(19) United States
(12) Patent Application Publication
(10) Pub. No.: US 2026/0152211 A1
(43) Pub. Date: Jun. 4, 2026

(54) SYSTEM FOR CONVEYING AT LEAST ONE TRANSPORT CAPSULE

(71) Applicant: CLAUDIO SUBACCHI, PIACENZA (IT)

(72) Inventor: CLAUDIO SUBACCHI, PIACENZA (IT)

(21) Appl. No.: 18/993,377

(22) PCT Filed: Jul. 13, 2023
(86) PCT No.: PCT/US2023/027591

§ 371 Date: Jan. 10, 2025

(30) Foreign Application Priority Data
Jul. 15, 2022 (IT) 102022000014977

(51) Int. Cl. B61B 13/10; F16L 9/14; F16L 17/067

(52) U.S. Cl. CPC B61B 13/10; F16L 9/14; F16L 17/067

(57) ABSTRACT

System for conveying at least one transport capsule comprising:
a pipe (2) comprising first and second trunk (21, 22) that are reciprocally assembled;
a coating (3) whose function is structural and of at least partially waterproofing the pipe (2) and comprising tensioned ribbon-shaped means (31) that wraps and compresses at least one portion of the pipe (2).

The ribbon-shaped means (31) is made of fibre-resin composite material and comprises said fibres impregnated in said resin.

### TECHNICAL FIELD

The present invention relates to a system for conveying at least one transport capsule, in particular an Hyperloop system.

### PRIOR ART

Hyperloop systems in which a capsule containing goods or people is conveyed into a low-pressure tube to reduce air friction are known. Projects to connect locations hundreds of kilometres away using this technology are also known. For example, the tube is made of steel and supported by means of pylons. There may possibly be two tubes arranged side by side, one per direction of travel.

A drawback of such a solution is the high costs of realization.

### OBJECT OF THE INVENTION

The technical task set and the objects specified are substantially attained by a system for conveying at least one transport capsule comprising the technical features as set out in one or more of the accompanying claims.

### BRIEF DESCRIPTION OF THE DRAWINGS

Further characteristics and advantages of the present invention will become more apparent from the indicative and thus non-limiting description of a preferred but non-exclusive embodiment of a system for conveying at least one transport capsule, as illustrated in the attached drawings, in which:

FIG. 1 shows a perspective view of a conduit according to the present invention;

FIG. 2 shows a component of the solution of FIG. 1;

FIG. 3 shows a component of the detail of FIG. 2;

FIG. 4 shows a component of the solution of FIG. 1;

FIG. 5 shows a detail of a component partially disassembled with respect to the image of FIG. 1;

FIG. 6 shows a magnification of a portion of FIG. 5.

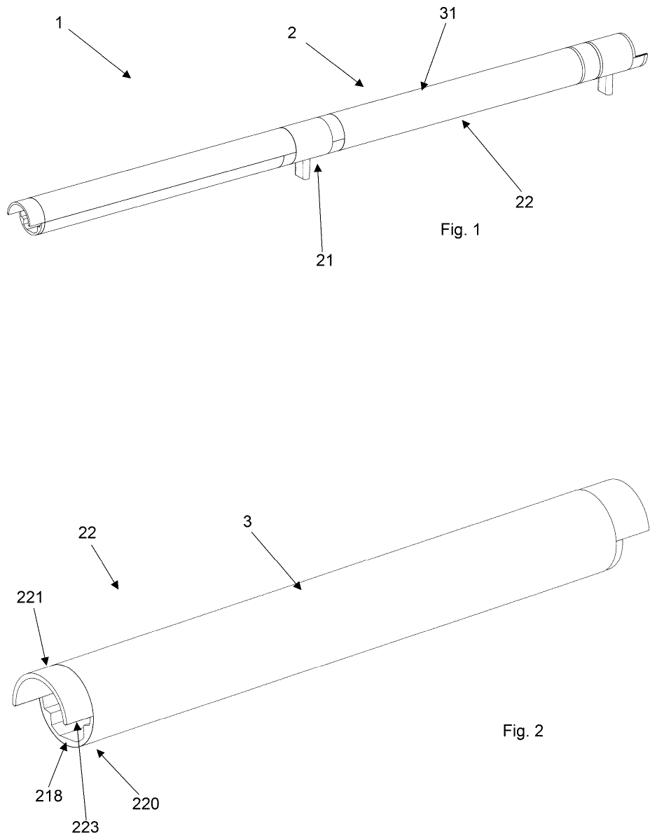

### DETAILED DESCRIPTION OF PREFERRED EMBODIMENTS OF THE INVENTION

In the attached figures a conduit for conveying at least one transport capsule is indicated with reference number 1. This capsule is suitable for transporting people or goods.

The conveying conduit 1 comprises a pipe 2. The pipe 2 is intended for the transit of the capsule. In turn the pipe 2 comprises a first and a second trunk 21, 22 that are reciprocally assembled. The first and second trunk 21, 22 are advantageously consecutive. Advantageously the first and/or the second trunk 21, 22 are at least partly made of concrete or of geopolymer or of alkali-activated material. At least 90% by weight of the first and/or second trunks 21, 22 are made of concrete or of geopolymer or of activated alkali material. Such materials are well known in the technical field and therefore not further detailed. In particular, activated alkali material can mean any binder system derived from the reaction of an alkali metal source (solid or in powder) with a solid silicate powder.

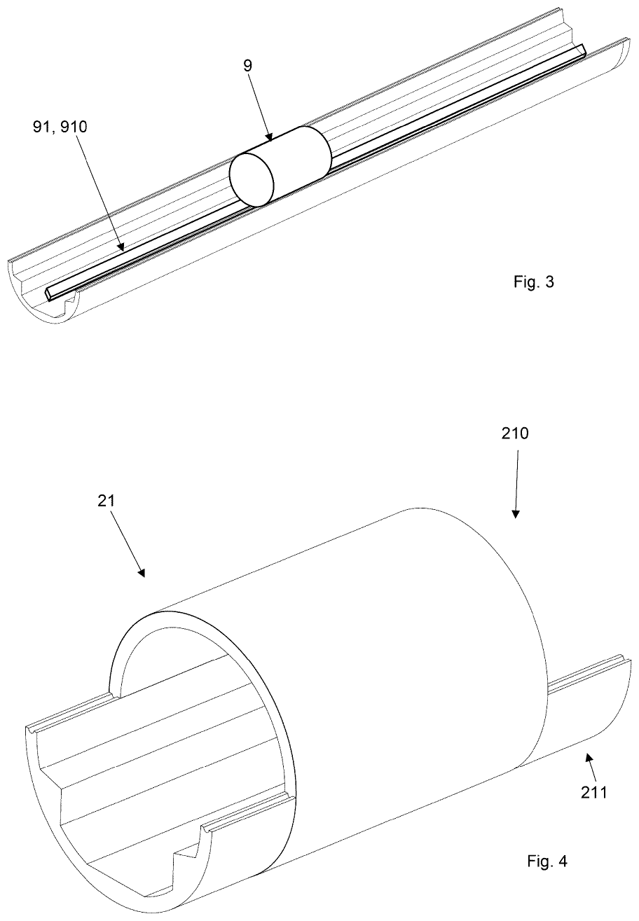

The first or second trunk may comprise two half-shells assembled to define a tubular body. Suitably one of the two half-shells is superimposed on the other (it is located above). For example FIG. 3 shows the lower half-shell. Suitably the pipe 2 is a modular structure of various trunks assembled together. What is described with reference to the first and/or second trunks 21, 22 can be advantageously repeated also for the other trunks.

Suitably the pipe 2 may comprise, duly interspersed with each other, support trunks comprising a base (which may also be a rest pillar). This base defines a point of rest to the ground or to other support. The first trunk 21 is an example of such support trunks.

The conduit 1 comprises a coating 3 for structural reinforcement and at least in part waterproofing of the pipe 2. The coating 3 comprises tensioned ribbon-shaped means 31 that wrap and compress at least one portion of the pipe 2, in particular of the first and/or second trunk 21, 22. The ribbon-shaped means 31 are made of resin-fibre composite material. The ribbon-shaped means 31 comprises longitudinal fibres impregnated in a resin (there may be a resin matrix in which the fibres are drowned or one or more fibres that is/are wrapped by the resin). In the preferred solution the fibre is a glass fibre or a carbon fibre or a basalt fibre. Suitably, they are inert to corrosion and chemical attacks so that the durability of the elements is greatly increased. The ribbon-shaped means 31 comprises a band, which suitably is made in the composite material described above, wrapped around the pipe 2.

The resin, for example, can be a polyester, vinyl ester, epoxy, polyurethane resin.

The fibre thus comprises a plurality of filaments. Conveniently, the filaments extend alongside each other. Preferably the filaments are not intertwined to define a weft and a warp. The resin allows an optimal distribution of the load between the filaments. For example, the ribbon-shaped means 31 can have a width comprised between 3 and 10 centimetres. The ribbon-shaped means 31 is preferably helically wound on the first and/or second trunk 21, 22. The various windings of the ribbon-shaped means 31 can also partially surmount each other. Suitably the ribbon-shaped means 31 completely wraps the first and/or the second trunk 21, 22. Advantageously the ribbon-shaped means 31 wraps the pipe 2. Suitably also the support trunks and the joining zone with the adjacent trunks has the coating 3.

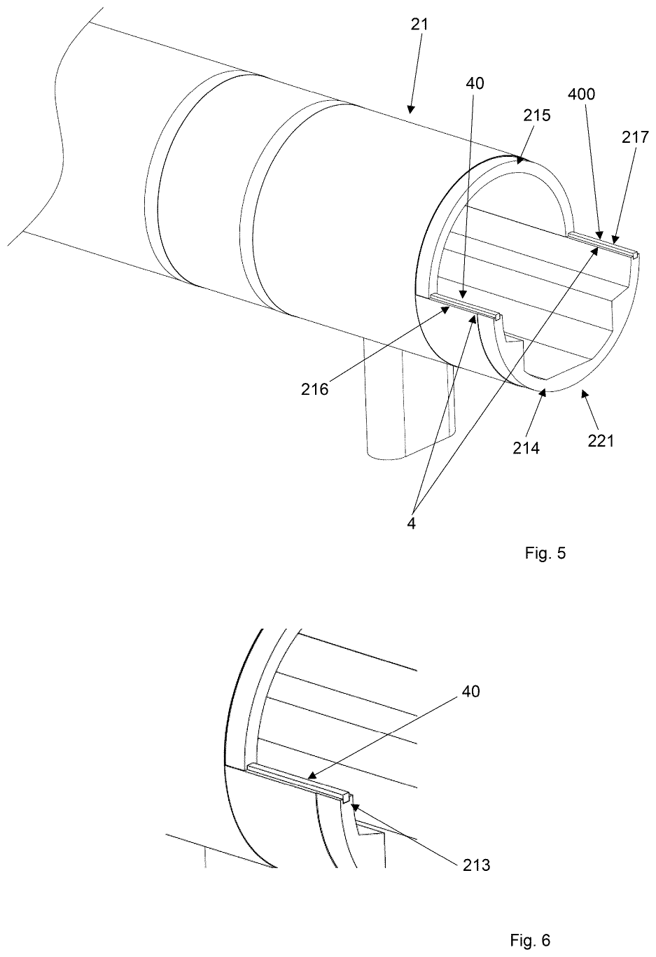

The first trunk 21 comprises an end portion 210 comprising a first projection 211 that extends from a first bottom edge 215 (see FIG. 5).

The second trunk 22 comprises an end portion 220 comprising a second projection 221 that extends from a second bottom edge 218 (see FIG. 2). The first and second projection 211, 221 are reciprocally associated.

The first projection 211 and the second projection 221 are reciprocally complementary (are therefore counter-shaped). In combination they define a tubular portion.

Suitably the first projection 211 surmounts the second projection 221 (therefore it lies higher). Suitably the zone where the first and second projections 211, 221 are coupled is covered by said ribbon-shaped means 31 that wraps around the pipe 2.

The conduit 1 comprises a dilating joint 4 between the first and second trunk 21, 22. This joint 4 suitably uses a male-female coupling.

In particular, the joint 4 comprises a first longitudinal dowel 40. Suitably the first dowel 40 is a longitudinal profile and the long side is aligned with the main direction of extension of the first trunk 21.

As exemplified in FIGS. 5 and 6 the first projection 211 comprises a first housing groove 213 of the first dowel 40. The second projection 221 comprises a second housing groove 223 of the first dowel 40. The first dowel 40 is inserted into the first and second groove 213, 223. It allows a longitudinal displacement between first and second trunk 21, 22.

Suitably the first projection 211 comprises a first end edge 214. Said first end edge 214 is arcuate, typically like an arc of a circle. The first end edge 214 is located at the maximum projection assumed by the first projection 211.

The first projection 211 comprises a first side 216 that connects the first end edge 214 and the first bottom edge 215.

The first groove 213 is obtained in the first side 216.

The first projection 211 comprises a second side 217 that connects the first end edge 214 and the first bottom edge 215. The first and second side 216, 217 extend parallel. The first and second side 216, 217 delimit on opposite sides the first projection 211.

The joint 4 also comprises a second dowel 400 that is at a joining zone between:
the second side 217; and
the second projection 221 of the second trunk 22 that overlaps the second side 217.

The first and second dowels 40, 400 extend parallel to each other along their main direction of extension.

Suitably the first dowel 40 is made of polytetrafluoroethylene (PTFE). Suitably also the second dowel 400 is made of such material.

In the preferred solution the first trunk 21 extends in width for more than 2 metres and less than 5 metres. Suitably a thickness of the wall of the first trunk 21 separating an inner zone from an outer environment is comprised between 2 and 10 centimetres.

The present invention also relates to a system for conveying at least one capsule comprising a conduit 1 having one or more of the characteristics described above.

The system for conveying comprises a capsule 9 that is movable inside the pipe 2. Suitably the system for conveying comprises means 92 for guiding the capsule 9 that extend along the pipe 2. For example the guide means 92 may comprise a rail or a track. Suitably the system for conveying comprises means for lifting the capsule from the guide means. The lifting means could be of the magnetic type (using the magnetic repulsion of an element integral with the capsule and the guide means) or by means of jets of pressurised fluid. They typically act at the guide means 92.

Suitably the system for conveying at least one capsule comprises depressurising means for depressurising the zone inside the pipe 2 with respect to the outer zone.

The system 10 also comprises movement means 91 for moving the capsule 9 along the pipe 2. The movement means 91 comprises at least one linear electric motor 910 that extends along the pipe 2.

The present invention achieves important advantages.

First of all, it allows to optimize the costs in that a cheaper construction material can be used thanks to an expedient (the coating with resin and longitudinal strengthening fibres) that at the same time waterproofs it and improves the structural characteristics thereof.

The invention as it is conceived is susceptible to numerous modifications and variants, all falling within the scope of the inventive concept characterised thereby. Further, all the details can be replaced with other technically equivalent elements. In practice, all the materials used, as well as the dimensions, can be any whatsoever, according to need.

1. A conduit for conveying at least one transport capsule comprising:
a pipe (2) comprising a first and a second trunk (21, 22) that are reciprocally assembled and intended for the transit of the capsule;
a coating (3) for structural reinforcement and at least partial waterproofing of the pipe (2) and comprising tensioned ribbon-shaped means (31) that wrap and compress at least one portion of the pipe (2); said ribbon-shaped means (31) being made of a resin-fibre composite material and comprising said fibres impregnated in said resin.

2. The conduit according to claim 1, characterised in that the first and/or the second trunk (21, 22) are at least partially made of concrete or of geopolymer or of alkali-activated material.

3. The conduit according to claim 1, characterised in that:
the first trunk (21) comprises an end portion (210) comprising a first projection (211) that extends from a first bottom edge (215);
the second trunk (22) comprises an end portion (220) comprising a second projection (221) that extends from a second bottom edge (218);
the first projection (211) and the second projection (221) being reciprocally associated.

4. The conduit according to claim 1, characterised in that it comprises a dilating joint (4) between the first and the second trunk (21, 22) that uses a male-female coupling.

5. The conduit according to claim 4, characterised in that the joint (4) comprises a first longitudinal dowel (40); the first projection (211) comprising a first housing groove (213) of the first dowel (40); the second projection (221) comprising a second housing groove (223) of the first dowel (40); the first dowel (40) being inserted into the first and into the second groove (213, 223).

6. The conduit according to claim 5, characterised in that said dowel (40) is made of PTFE.

7. The conduit according to claim 5, characterised in that:
the first projection (211) comprises a first end edge (214);
the first projection (211) comprises a first side (216) that connects the first end edge (214) and the first bottom edge (215); the first groove (213) being obtained in the first side (216).

8. The conduit according to claim 7, characterised in that the first projection (211) comprises a second side (217) that connects the first end edge (214) and the first bottom edge (215); the joint (4) comprising a second dowel (400) that is at a joining zone between the second side (217) and the second projection (221) of the second trunk (22) that overlaps the second side (217).

9. A system for conveying at least one transport capsule, characterised in that it comprises:
a conduit according to claim 1;
a capsule (9) that is movable inside the pipe (2);
depressurising means for depressurising the zone inside the pipe (2) with respect to the outer zone.

10. The system according to claim 9, characterised in that it comprises movement means (91) for moving the capsule (9) along the pipe (2) comprising at least one linear electric motor (910) that extends along the pipe (2).

11. The conduit according to claim 3, characterised in that it comprises a dilating joint (4) between the first and the second trunk (21, 22) that uses a male-female coupling.
